(19) United States
(12) Patent Application Publication
(10) Pub. No.: US 2009/0254013 A1
(43) Pub. Date: Oct. 8, 2009

(54) Massage machine

(75) Inventors: Satoshi Kajiyama, Hikone (JP); Takayoshi Tanizawa, Higashioumi (JP); Shouhei Taniguchi, Osaka (JP); Daisuke Tsukada, Hikone (JP); Yuuichi Nishibori, Hikone (JP); Yoshiko Tsuji, Nagahama (JP)

Correspondence Address: BACON & THOMAS, PLLC, 625 SLATERS LANE, FOURTH FLOOR, ALEXANDRIA, VA, 22314-1176, US

(73) Assignee: Panasonic Electric Works Co., Ltd., Kadoma-shi (JP)

(21) Appl. No.: 12/385,107

(22) Filed: Mar. 31, 2009

(30) Foreign Application Priority Data
Mar. 31, 2008 (JP) 2008-093582

(51) Int. Cl. A61H 7/00

(52) U.S. Cl. 601/134

(57) ABSTRACT

A massage machine includes a seat portion, a backrest arranged at the rear of the seat portion, and a massage mechanism including a treatment member movable along the backrest in an up-and-down direction and/or in a left-and-right direction. The massage machine further includes a position detection unit for detecting an up-and-down position and/or a left-and-right position of the treatment member, a force detection unit for detecting the force applied from a user to the treatment member, a physique detection unit for detecting the physique of the user, and a control unit for operating the treatment member according to pre-stored treatment data. The control unit is configured to change the up-and-down position and/or the left-and-right position of the treatment member if the force detected by the force detection unit exceeds a threshold value.

### FIELD OF THE INVENTION

The present invention relates to a massage machine that performs massage on a user with a treatment member.

### BACKGROUND OF THE INVENTION

Conventionally, there is known a massage machine for performing massage depending on the physique of a user. The massage machine includes a position detection unit for detecting the position of a treatment member, a force detection unit for detecting the force borne by the treatment member and a physique detection unit for detecting the physique (or bodily shape) of the user (see, e.g., Japanese Patent Laid-open Publication No. 2007-29398). The massage machine is designed to execute so-called position control by which the treatment member is moved along a treatment track under the control of a control unit according to treatment track data pre-stored in a storage unit.

As another prior art example, there is known a massage machine designed to execute so-called force control by which a treatment member is operated under the control of a control unit in such a way that the force borne by the treatment member matches with the force data pre-stored in a storage unit.

In case of the massage machine that performs the position control, the treatment member is operated to follow a predetermined track. For that reason, even if the user receives an overly great force from the treatment member and feels painful, the treatment member continues to move along the predetermined track regardless of the force applied to the user. Therefore, it is impossible for the user to avoid pain unless a suitable measure is taken, e.g., unless the user moves his or her body or changes the setting of the track of the treatment member.

In case of the massage machine that performs the force control, if a force great enough to make the user feel painful is applied to the user, the force falls outside the pre-stored force data. Therefore, the treatment member is operated to move away from the user to reduce the force. However, in case the increase in the force is due to the user's coming close to the treatment member, it is impossible to have the treatment member moved away from the user. This often makes it difficult to reduce the force applied to the user.

### SUMMARY OF THE INVENTION

In view of the above, the present invention provides a massage machine for executing force control by which to control the force applied to a user by a treatment member, the massage machine being capable of performing massage in such a manner as not to apply an overly great force to the user, with no need for the user to move his or her body and without having to change the setting of a track of the treatment member.

In accordance with an aspect of the invention, there is provided a massage machine including:

a seat portion;

a backrest arranged at the rear of the seat portion;

a massage mechanism including a treatment member movable along the backrest in an up-and-down direction and/or in a left-and-right direction;

a position detection unit for detecting an up-and-down position and/or a left-and-right position of the treatment member;

a force detection unit for detecting the force applied from a user to the treatment member;

a physique detection unit for detecting the physique of the user; and

a control unit for operating the treatment member according to pre-stored treatment data, wherein the control unit is configured to change the up-and-down position and/or the left-and-right position of the treatment member if the force detected by the force detection unit exceeds a threshold value.

With this configuration, it is possible to have the treatment member automatically moved away from the user if an overly great force exceeding a threshold value is applied to the user by the treatment member.

In accordance with the present invention, it is possible to change the position of the treatment member and to perform massage in such a manner as not to apply an overly great force to the user, with no need for the user to move his or her body and without having to change the setting of a track of the treatment member.

### BRIEF DESCRIPTION OF THE DRAWINGS

The objects and features of the present invention will become apparent from the following description of embodiments, given in conjunction with the accompanying drawings, in which:

FIG. 1 is a block diagram showing a circuit of a massage machine in accordance with one embodiment of the present invention;

FIG. 2 is a perspective view showing a massage mechanism employed in the massage machine in accordance with the embodiment of the present invention;

FIG. 3 is a side view of the massage machine in accordance with the embodiment of the present invention;

FIG. 4A is a front view depicting the upper half of the user's body, FIG. 4B is a partial plan view thereof and FIG. 4C is a side view thereof; and

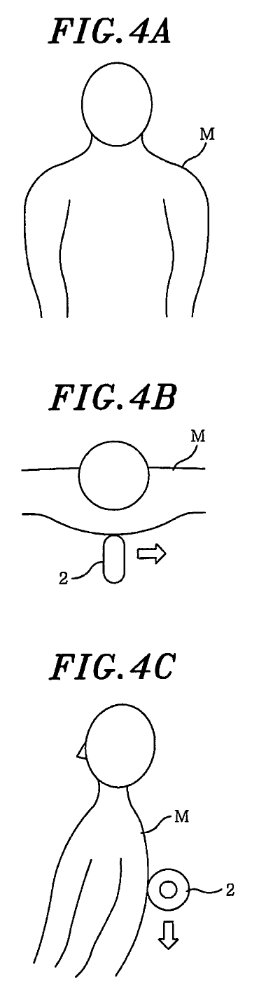

FIG. 5 is a flowchart illustrating how to change the position of a treatment member of the massage machine.

### DETAILED DESCRIPTION OF THE PREFERRED EMBODIMENTS

Hereinafter, one embodiment of the present invention will be described with reference to the accompanying drawings which form a part hereof.

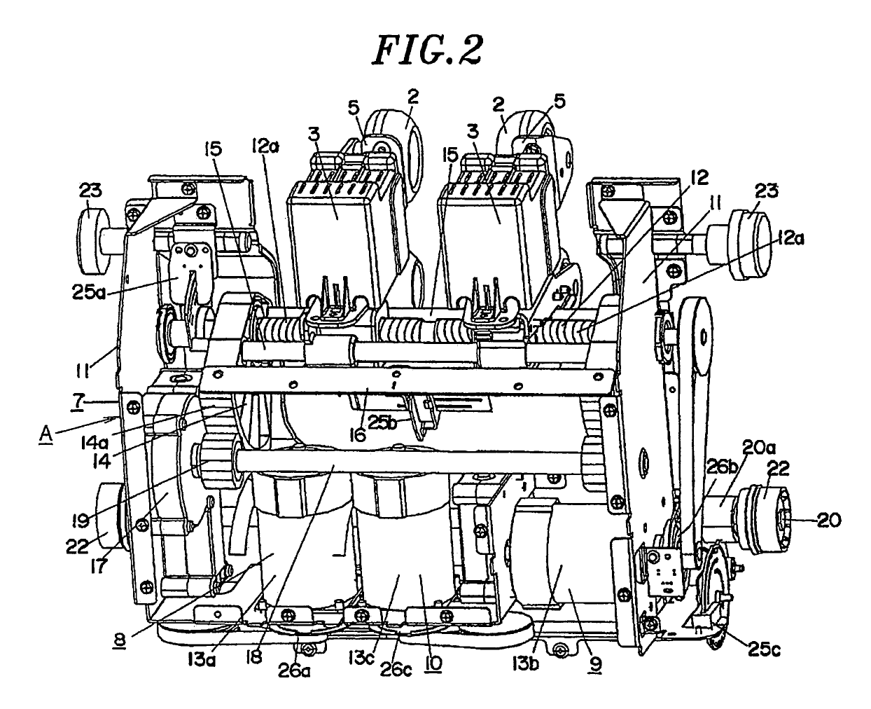

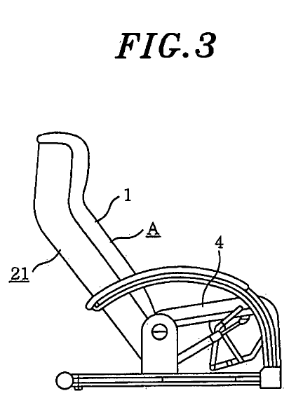

Referring to FIGS. 2 and 3, the massage machine A of the present embodiment is a chair-type massage machine and includes a seat portion 4 and a backrest 1 arranged at the rear of the seat portion 4. The backrest 1 is provided with treatment members 2 for performing a mechanical treatment operation. While a user M sits on the seat portion 4 and leans against the backrest 1, the treatment members 2 perform a mechanical treatment operation to carry out massage.

The massage machine A includes a main block 7 as one of major components thereof. The main block 7 is arranged in the backrest 1 so as to move upwards and downwards.

The main block 7 includes independently operable drive units for causing the treatment members 2 to perform massage in the up-and-down, left-and-right and back-and-forth directions. Each of the treatment members 2 describes a massage track as one or more of the drive units are driven.

In the embodiment illustrated in the accompanying drawings, the drive units include a strong-and-weak massage drive unit 8 for operating the treatment members 2 toward and away from the user M who leans against the backrest 1 (namely, in, the back-and-forth direction), a transverse drive unit 9 for operating the treatment members 2 to perform massage in the transverse direction (namely, in the left-and-right direction) and an up-and-down drive unit 10 for operating the treatment members 2 to perform massage in the up-and-down direction. The strong-and-weak massage drive unit 8, the transverse drive unit 9 and the up-and-down drive unit 10 constitute a massage mechanism.

The main block 7 includes side plates 11 and a transverse drive shaft 12 rotatably installed between the side plates 11. The transverse drive unit 9 is configured to rotate the transverse drive shaft 12 upon rotation of a motor 13b. On the outer surface of the transverse drive shaft 12, there are formed thread portions 12a. The left thread portion 12a and the right thread portion 12a, which are respectively located on the left and right sides of the longitudinal center of the transverse drive shaft 12, turn in the mutually reverse directions. Transverse feeding nuts of treatment arms 5 each having a vibration device 3 are threadedly coupled to the left and right thread portions 12a of the transverse drive shaft 12. Rotational movement of the treatment arms 5 is caused by strong-and-weak massage drive gears 14 which will be described later. Forward or reverse rotation of the motor 13b of the transverse drive unit 9 results in forward or reverse rotation of the transverse drive shaft 12 operatively connected to the motor 13b through a driving pulley, a belt and a driven pulley. As a consequence, the treatment arms 5 are moved toward or away from each other in the transverse direction (the left-and-right direction).

A pair of strong-and-weak massage drive gears 14 is arranged in the opposite outer sides of the transverse movement range of the treatment arms 5. The strong-and-weak massage drive gears 14 include arc-shaped gear portions 14a each having a sector-like gear body and gear teeth formed on the arc-shaped circumference of the gear body. Each of the strong-and-weak massage drive gears 14 has a center hole to which the transverse drive shaft 12 is fitted in a rotatable manner. The strong-and-weak massage drive gears 14 are interconnected by a connecting member 16. At least one transverse drive spindle 15 (two transverse drive spindles in the present embodiment) is installed between the strong-and-weak massage drive gears 14. The transverse drive spindle 15 extends parallel to the transverse drive shaft 12 and is inserted into the holes of the treatment arms 5 in such a way that the treatment arms 5 can move along the transverse drive spindle 15.

The arc-shaped gear portions 14a are meshed with a pair of transfer gears 19 for transferring rotation of a motor 13a of the strong-and-weak massage drive unit 8 which will be described later.

Rotation of the motor 13a of the strong-and-weak massage drive unit 8 is transferred through a transmission mechanism to the strong-and-weak massage drive shaft 18 rotatably supported on a gear box 17 and one of the side plates 11. The strong-and-weak massage drive shaft 18 is provided at its opposite ends with a pair of transfer gears 19 meshing with the arc-shaped gear portions 14a of the strong-and-weak massage drive gears 14. As the motor 13a of the strong-and-weak massage drive unit 8 turns forwards and backwards, the strong-and-weak massage drive shaft 18 is rotated to thereby rotate the transfer gears 19, which leads to rotation of the arc-shaped gear portions 14a about the transverse drive shaft 12. As a result, the treatment arms 5 are rotated about the transverse drive shaft 12, thereby changing the body-side protrusion amount (i.e., the back-and-forth protrusion amount) of the treatment members 2 provided at the tip ends of the treatment arms 5. In other words, rotation of the treatment arms 5 results in arc movement of the treatment members 2 (i.e., arc movement of the treatment members 2 about the axis of the transverse drive shaft 12 in the present embodiment). Thus the treatment members 2 are moved in the up-and-down and back-and-forth directions, thereby changing the intensity of the force with which the treatment members 2 make contact with the user's body.

The up-and-down drive unit 10 provided in the main block 7 causes a motor 13c as a drive power source to turn clockwise and counterclockwise, thereby rotating an up-and-down drive shaft 20 provided with pinions 20a and roller portions 22 at its opposite ends. Rotation of the up-and-down drive shaft 20 results in forward or backward rotation of the pinions 20a.

The roller portions 22 of the up-and-down drive shaft 20 are mounted to up-and-down rails (not shown) provided in the frame of the backrest 1 of a chair 21 shown in FIG. 3 so that the main block 7 can move in the up-and-down direction. The up-and-down rails are provided with racks meshing with the pinions 20a. Forward or backward rotation of the motor 13c of the up-and-down drive unit 10 results in forward or backward rotation of the pinions 20a meshing with the racks, thus causing the main block 7 (namely, the treatment members 2 provided in the main block 7) to move upwards or downwards. In this regard, rollers 23 are rotatably attached to the upper portions of the side plates 11 of the main block 7. The rollers 23 are also fitted to the up-and-down rails for movement in the up-and-down direction.

Sensors for detecting the operative position of the treatment members 2 associated with the operation of the respective drive units and sensors for detecting the velocity of the treatment members 2 associated with the operation of the respective drive units are provided in the strong-and-weak massage drive unit 8 for operating the treatment members 2 toward and away from the user's body, the transverse drive unit 9 for operating the treatment members 2 in the transverse direction and the up-and-down drive unit 10 for operating the treatment members 2 in the up-and-down direction.

Responsive to the signals from the sensors of the respective drive units, a control unit 27 is configured to control the massage operation by which to operate one of the drive units or the massage operation by which to jointly operate two or more of the drive units. The massage machine A is provided with an operating portion 6 including a remote controller or the like. The user M can input different commands through the operating portion 6 to perform various kinds of massage operations.

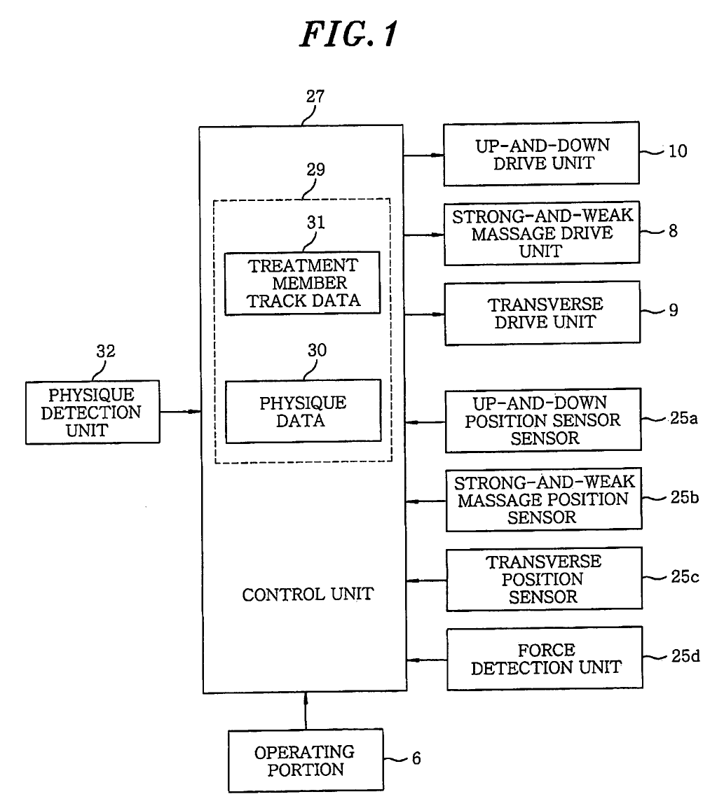

Referring to FIG. 1, a sensor 25a (a strong-and-weak massage position sensor) for detecting the operative position of the treatment members 2 associated with the operation of the strong-and-weak massage drive unit 8 and a sensor 26a (a strong-and-weak massage rotation sensor) for detecting the back-and-forth moving velocity of the treatment members 2 associated with the operation of the strong-and-weak massage drive unit 8 are provided in the strong-and-weak massage drive unit 8 of the main block 7. A sensor 25b (a transverse position sensor) for detecting the transverse position of the treatment members 2 associated with the operation of the transverse drive unit 9 and a sensor 26b (a transverse rotation sensor) for detecting the transverse moving velocity of the treatment members 2 associated with the operation of the transverse drive unit 9 are provided in the transverse drive unit 9. A sensor 25c (an up-and-down position sensor) for detecting the up-and-down position of the treatment members 2 associated with the operation of the up-and-down drive unit 10 and a sensor 26c (an up-and-down rotation sensor) for detecting the up-and-down moving velocity of the treatment members 2 associated with the operation of the up-and-down drive unit 10 are provided in the up-and-down drive unit 10. Alternatively, only the sensor 25c for detecting the up-and-down position of the treatment members 2 associated with the operation of the up-and-down drive unit 10 may be provided in the up-and-down drive unit 10. The strong-and-weak massage position sensor 25a, the transverse position sensor 25b and the up-and-down position sensor 25c constitute a position detector unit 25. In the present embodiment, the massage machine A includes a force detection unit 28 for detecting the force borne by the treatment members 2. Examples of the force detection unit 28 include, but are not particularly limited to, a strain gauge and a device for measuring the displacement of an elastic body.

In case the motor 13a is controlled by the control unit 27, it is necessary to control the operative position and the moving velocity of the treatment members 2 associated with the operation of the motor 13a. In this case, the operative position and the moving velocity of the treatment members 2 associated with the operation of the motor 13a are detected by the strong-and-weak massage position sensor 25a and the strong-and-weak massage rotation sensor 26a. The control unit 27 controls the motor 13a so as to perform the strong-and-weak massage operation in a preset manner. In case the motor 13b is controlled by the control unit 27, it is necessary to control the transverse position and the transverse moving velocity of the treatment members 2 associated with the operation of the motor 13b. In this case, the transverse position and the transverse moving velocity of the treatment members 2 associated with the operation of the motor 13b are detected by the transverse position sensor 25b and the transverse rotation sensor 26b. The control unit 27 controls the motor 13b so as to perform the transverse drive operation in a preset manner. In case the motor 13c is controlled by the control unit 27, it is necessary to control the up-and-down position and the up-and-down moving velocity of the treatment members 2 associated with the operation of the motor 13c. In this case, the up-and-down position and the up-and-down moving velocity of the treatment members 2 associated with the operation of the motor 13c are detected by the up-and-down position sensor 25c and the up-and-down rotation sensor 26c. The control unit 27 controls the motor 13c so as to perform the up-and-down drive operation in a preset manner. In case only the up-and-down position sensor 25c for detecting the up-and-down position of the treatment members 2 associated with the operation of the motor 13c is provided in the up-and-down drive unit 10, the up-and-down position of the treatment members 2 is detected by the up-and-down position sensor 25c. The control unit 27 controls the motor 13c so as to perform the up-and-down drive operation in a preset manner.

In the present embodiment, the massage machine A includes a physique detection unit 32 for detecting the physique of the user M. For detection of the user's physique, the user M is first allowed to sit on the seat portion 4 and lean against the backrest 1. Then the position of the shoulder or the waist is determined by moving the treatment members 2 in the up-and-down direction while causing the treatment members 2 to press the user M. Determination of the position of the shoulder or the waist is made by, e.g., a method of determining the position of the shoulder or the waist based on the back-and-forth position of the treatment members 2 when the treatment members 2 are moved in the up-and-down direction while maintaining constant the force borne by the treatment members 2 or a method of determining the force borne by the treatment members 2 when the treatment members 2 are moved in the up-and-down direction while maintaining constant the back-and-forth position of the treatment members 2. In this case, the control unit 27 and the treatment members 2 constitute the physique detection unit 32. As an alternative example of the physique detection unit 32, a piezoelectric sensor may be provided in the backrest 1 or the seat portion 4 of the chair 21 to detect the user's physique.

Data 30 of the physique of the user M detected by the physique detection unit 32 are stored in a storage unit 29 controlled by the control unit 27.

In the massage machine A, the control unit 27 controls the treatment members 2 using the treatment data pre-stored in the storage unit 29. The control unit 27 performs either the position control by which the treatment members 2 are operated to move along a treatment track according to treatment member track data 31 as the treatment data or the force control by which the treatment members 2 are operated according to force data as the treatment data.

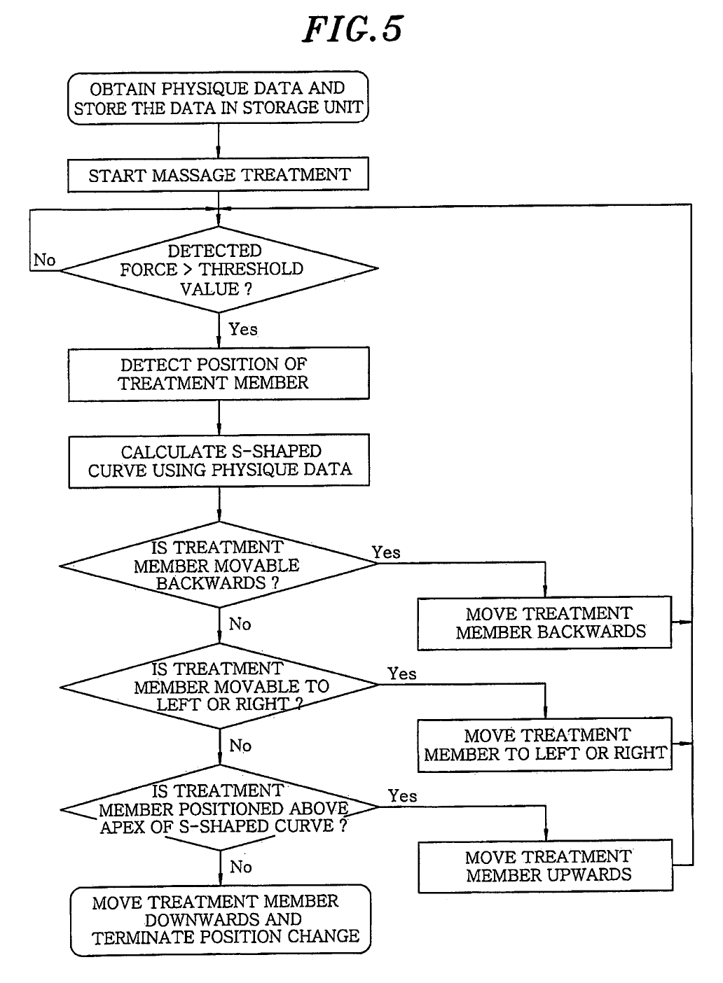

In the present invention, the position of the treatment members 2 is changed if the force detected by the force detection unit 28 exceeds a threshold value. The tasks of changing the position of the treatment members 2 are performed as follows. Referring to FIG. 5, the treatment members 2 are first moved backwards (in the weak massage direction) away from the user M if such movement is possible. If the backward movement is impossible, the treatment members 2 are subjected to a change in the treatment position, namely the up-and-down position and/or the left-and-right position. The change in the treatment position is performed according to the physique data 30 detected by the physique detection unit 32.

The position of the treatment members 2 is recognized at the time when the detected force exceeds the threshold value. Then the treatment members 2 are moved in the left-and-right direction if such movement is possible. The human body has a convex shape in the left-and-right direction of the back with the spine (or the center of the back) being an apex. Therefore, the pressing force applied to the user M grows smaller if the position of the treatment members 2 is changed away from the spine in the left-and-right direction.

In case there is no room for changing the position of the treatment members 2 away from the spine in the left-and-right direction, namely in case the treatment members 2 are positioned at or near the left or right end at the moment when the detected force exceeds the threshold value, then the treatment members 2 are moved in the up-and-down direction. The human body has an “S”-shaped curve in the up-and-down direction with the back being an apex. Therefore, the treatment members 2 are moved upwards if they are positioned above the apex. The treatment members 2 are moved downwards if they are positioned below the apex. This makes it possible to reduce the pressing force applied to the user M.

Alternatively, the pressing force applied to the user M may be reduced by operating the treatment members 2 to describe another track when the detected force exceeds the threshold value. In this case, however, it becomes necessary to execute another program, which leads to increased cost.

With the present invention, it is possible to automatically move the treatment members 2 if an excessive force exceeding the threshold value is applied to the user M. This eliminates the need for the user M to move his or her body or to change the setting of a track of the treatment members 2.

In addition, there is no need to greatly change the control unit 27, which makes it possible to perform massage in a cost-effective manner.

While the invention has been shown and described with respect to the embodiments, it will be understood by those skilled in the art that various changes and modification may be made without departing from the scope of the invention as defined in the following claims.

What is claimed is:

1. A massage machine comprising:
a seat portion;
a backrest arranged at the rear of the seat portion;
a massage mechanism including a treatment member movable along the backrest in an up-and-down direction and/or in a left-and-right direction;
a position detection unit for detecting an up-and-down position and/or a left-and-right position of the treatment member;
a force detection unit for detecting the force applied from a user to the treatment member;
a physique detection unit for detecting the physique of the user; and
a control unit for operating the treatment member according to pre-stored treatment data, wherein the control unit is configured to change the up-and-down position and/or the left-and-right position of the treatment member if the force detected by the force detection unit exceeds a threshold value.

2. The massage machine of claim 1, wherein the control unit is configured to move the treatment member backwards away from the user if the treatment member is movable backwards when the force detected by the force detection unit exceeds the threshold value and wherein the control unit is configured to change the up-and-down position and/or the left-and-right position of the treatment member if the treatment member is immovable backwards when the force detected by the force detection unit exceeds the threshold value.
